(19) United States
(12) Patent Application Publication
(10) Pub. No.: US 2015/0330769 A1
(43) Pub. Date: Nov. 19, 2015

(54) OCT APPARATUS, SS-OCT APPARATUS, AND METHOD OF ACQUIRING SS-OCT IMAGE

(71) Applicant: CANON KABUSHIKI KAISHA, Tokyo (JP)

(72) Inventors: Tomohiro Yamada, Yokohama-shi (JP); Takefumi Ota, Nagareyama-shi (JP); Ryo Kuroda, Komae-shi (JP)

(21) Appl. No.: 14/442,074

(22) PCT Filed: Nov. 14, 2013
(86) PCT No.: PCT/JP2013/081334

§ 371 Date: May 11, 2015

(30) Foreign Application Priority Data
Nov. 16, 2012 (JP) 2012-251920

(51) Int. Cl. G01B 9/02; G06T 11/00; G06T 1/00

(52) U.S. Cl. CPC G01B 9/02091; G06T 1/0007; G06T 11/005; G01B 9/02007; G06T 2211/40

(57) ABSTRACT

The OCT apparatus includes a first light source unit changing an optical wavelength, a second light source unit changing an optical wavelength over a wavelength range different from and partially overlapping with that of the first light source unit, a signal generating unit receiving light from the light source units to generate signals at an equal wave number interval, an interference optical system splitting the light from the first and second light source units into illumination light illuminating an object and reference light, to generate first and second interference light, a light detecting unit receiving interference light, and an information acquiring unit acquiring a tomographic image of the object by linking temporal waveforms of intensities of the first and second interference light. The information acquiring unit links the temporal waveforms of the intensities of the first and second interference light based on the signal generated from the signal generating unit.

### TECHNICAL FIELD

The present invention relates to an OCT apparatus, a swept source optical coherence tomography apparatus (SS-OCT apparatus), and a method of acquiring an SS-OCT image.

### BACKGROUND ART

In a technique for varying an oscillation wavelength of a light source, particularly a laser light source, it is desired to achieve both a high speed wavelength sweep and a thin line width.

As one of examples using the variable wavelength (wavelength swept) light source, there is known a swept source optical coherence tomography (SS-OCT) apparatus. In this SS-OCT apparatus, as disclosed in PTL 1, spectrum interference is used for obtaining depth information. Because a spectroscope is not used, light intensity loss is small, and it is expected to acquire an image with high signal-to-noise ratio (hereinafter referred to as an SN ratio or SNR).

When structuring a medical imaging apparatus to which the SS-OCT technique is applied, image acquiring time can be shorter as a sweep speed is higher, which is suitable for observing a living biological tissue. In addition, because a space resolution of a tomographic image can be higher as a wavelength sweep width is wider, these parameters are important. Specifically, a depth resolution can be expressed by the following expression:

$$\frac{2 ln 2}{π} \times \frac{{λ}_{0}^{2}}{Δ λ}$$

where Δλ represents a wavelength sweep width, and λ0 represents an oscillation wavelength.

Therefore, in order to improve the depth resolution, it is necessary to expand the wavelength sweep width, and hence a wavelength swept light source having a wide-band wavelength sweep width is desired.

The OCT technique is a technique that can acquire a tomographic image up to the depth of few millimeters with a depth resolution of few microns, and is used for fundus imaging and the like. As described above, in order to acquire an image in a wide-band wavelength region, a wavelength swept light source having a wide-band wavelength sweep width is necessary, but development thereof is not easy. Therefore, it is considered to realize a wide-band interference signal acquiring band using multiple light sources having different wavelength bands to be swept that are partially overlapped with each other, so as to acquire interference signals of the individual wavelength bands, and by linking and combining the interference signals at a predetermined wavelength (corresponding optical frequency) after acquiring the interference signals.

### CITATION LIST

### Patent Literature

PTL 1: Japanese Patent Application Laid-Open No. 2009-244232

### SUMMARY OF INVENTION

### Technical Problem

However, when trying to obtain a light source having a wide-band light emission wavelength by this method, there is a problem as follows.

In order to structure a wide band SS-OCT using multiple wavelength swept light sources, it is necessary to link the interference signals acquired by the respective multiple wavelength swept light sources at an optical frequency corresponding to the same light emission wavelength as described above. If the optical frequency at which the interference signals acquired by using the respective multiple light sources are linked is different between the interference signals, phases of individual frequency components contained in the acquired interference signals (OCT signals are acquired as interference spectra having different frequency components in accordance with distances of reflecting objects) are discontinuously linked. For this reason, noise may occur in the OCT image, and the SN ratio of the OCT image is deteriorated.

In addition, control is possible to switch the light sources or to link the interference signals at timing when a wavelength monitor such as a spectroscope detects that the light emission wavelength becomes a predetermined frequency. However, for this control, it is necessary to dispose an additional high-accuracy absolute wavelength monitor in the apparatus, which causes complicated structure of the apparatus.

Further, because this signal processing does not perform a final evaluation of the OCT image, there is a problem in that even if there is a room for further improving the SNR of the acquired OCT image, this state cannot be detected.

### Solution to Problem

In view of the above-mentioned problem, the present invention can provide an OCT apparatus, an SS-OCT apparatus, and a method of acquiring an SS-OCT image, which may achieve higher image quality and improved SNR of an OCT image without using a complicated device.

According to one embodiment of the present invention, there is provided an OCT apparatus, including: a first light source unit that changes an optical wavelength; a second light source unit that changes an optical wavelength over a wavelength range different from and partially overlapping with a wavelength range of the first light source unit; a signal generating unit for receiving light emitted from the first light source unit and light emitted from the second light source unit so as to generate a signal at an equal wave number interval; an interference optical system for splitting each of the light emitted from the first light source unit and the light emitted from the second light source unit into illumination light that illuminates an object and reference light, so as to generate interference light of reflection light of the light illuminating the object and the reference light; a light detecting unit for receiving first interference light obtained based on the light emitted from the first light source unit and second interference light obtained based on the light emitted from the second light source unit; and an information acquiring unit for acquiring a tomographic image of the object by linking a temporal waveform of intensity of the first interference light and a temporal waveform of intensity of the second interference light, in which the information acquiring unit links the temporal waveform of the intensity of the first interference light and the temporal waveform of the intensity of the second interference light based on the signal generated from the signal generating unit.

Further, according to one embodiment of the present invention, there is provided an SS-OCT apparatus, including: a light source unit including multiple wavelength swept light sources, and a k-clock optical system for measuring wavelength sweep speeds of the multiple wavelength swept light sources; an interference measuring unit including an interference optical system for illuminating an object with light emitted from the light source unit so as to obtain an interference signal; and a signal processing unit for performing signal processing including image processing with the interference signal obtained by the interference measuring unit, in which: the light source unit includes, as the multiple wavelength swept light sources, the wavelength swept light sources including at least a first wavelength swept light source and a second wavelength swept light source having different and partially overlapping wavelength ranges; and the signal processing unit is configured to: link a first interference signal of the first wavelength swept light source and a second interference signal of the second wavelength swept light source, which are obtained by the interference measuring unit, at a link optical frequency found by using a signal obtained by the k-clock optical system, in order to suppress noise generated when phases of respective frequency components contained in the first interference signal and the second interference signal are discontinuously linked; and produce an OCT image based on the first interference signal and the second interference signal linked at the link optical frequency.

Further, according to one embodiment of the present invention, there is provided a method of acquiring an SS-OCT image by illuminating an object with light emitted from a light source unit including multiple wavelength swept light sources and a k-clock optical system for measuring wavelength sweep speeds of the multiple wavelength swept light sources, and performing image processing of an obtained interference signal using a signal processing unit for performing signal processing including the image processing, the method including: a first step of acquiring a first interference signal of the first wavelength swept light source and a second interference signal of the second wavelength swept light source using at least two wavelength swept light sources including a first wavelength swept light source and a second wavelength swept light source having different and partially overlapping wavelength ranges as the multiple wavelength swept light sources; a second step of determining a link optical frequency using a signal obtained by the k-clock optical system in order to suppress noise generated due to discontinuous link of phases of respective frequency components contained in the first interference signal and the second interference signal, when the first interference signal and the second interference signal are linked; and a third step of linking the first interference signal and the second interference signal at the link optical frequency determined by using the k-clock optical system, so as to produce an OCT image based on the linked first interference signal and second interference signal.

### Advantageous Effects of Invention

The present invention can realize the OCT apparatus, the SS-OCT apparatus, and the method of acquiring an SS-OCT image, which may achieve higher image quality and improved SNR of an OCT image without using a complicated device.

Further features of the present invention will become apparent from the following description of exemplary embodiments with reference to the attached drawings.

### BRIEF DESCRIPTION OF DRAWINGS

FIG. 1 illustrates a structural example of an SS-OCT apparatus and a method of acquiring an SS-OCT image according to an embodiment of the present invention.

FIG. 2 is a graph for explaining wavelength swept light sources in the SS-OCT apparatus and the method of acquiring an SS-OCT image according to the embodiment of the present invention.

FIG. 3 is a graph for explaining temporal waveforms of an interference signal, a corresponding k-clock signal, and light source intensity in the SS-OCT apparatus and the method of acquiring an SS-OCT image according to the embodiment of the present invention when an object 108 is illuminated with light using the wavelength swept light sources.

FIGS. 4A and 4B are graphs for explaining a method of linking interference signals obtained by different light sources at the same optical frequency in the SS-OCT apparatus and the method of acquiring an SS-OCT image according to the embodiment of the present invention.

FIG. 5 is a graph for explaining a specific structural example of linking interference signals obtained by different light sources at the same optical frequency in the SS-OCT apparatus and the method of acquiring an SS-OCT image according to the embodiment of the present invention.

FIGS. 6A and 6B illustrate a structural example of an SS-OCT apparatus and a method of acquiring an SS-OCT image according to an example of the present invention.

FIGS. 7A and 7B are graphs for explaining a wavelength sweep period in the SS-OCT apparatus and the method of acquiring an SS-OCT image according to the example of the present invention.

FIG. 8 illustrates a structural example of an SS-OCT apparatus and a method of acquiring an SS-OCT image in another form of the example of the present invention.

FIG. 9 shows a signal waveform when a k-clock signal is generated by an interferometer and differential detection is performed using signals from two output ports of the interferometer in the embodiment of the present invention.

FIG. 10 shows an example of a temporal change of an optical frequency of light emitted from an SSG-DBR laser in the embodiment of the present invention.

FIG. 11 is a graph for explaining an example of an interference signal obtained by using the SSG-DBR laser in the embodiment of the present invention.

### DESCRIPTION OF EMBODIMENTS

An optical coherence tomography (OCT) apparatus according to an embodiment of the present invention includes a first light source unit that changes an optical wavelength and a second light source unit that changes an optical wavelength over a wavelength range different from and partially overlapping with a wavelength range of the first light source unit. Further, the OCT apparatus includes a signal generating unit for receiving light emitted from each of the first light source unit and the second light source unit so as to generate a signal at an equal wave number interval. Further, the OCT apparatus includes an interference optical system for splitting the light emitted from each of the first light source unit and the second light source unit into illumination light that illuminates an object and reference light, so as to generate interference light of reflection light of the light illuminating the object and the reference light. Further, the OCT apparatus includes a light detecting unit for receiving first interference light obtained by the light emitted from the first light source unit and second interference light obtained by the light emitted from the second light source unit. Further, the OCT apparatus includes an information acquiring unit for acquiring information, typically, a tomographic image of the object by linking a temporal waveform of intensity of the first interference light and a temporal waveform of intensity of the second interference light. Further, the information acquiring unit links the temporal waveform of the intensity of the first interference light and the temporal waveform of the intensity of the second interference light based on the signal generated by the signal generating unit.

The first light source unit is a light source that changes wavelength of emitted light with time. The second light source unit emits light in a wavelength range different from that of the first light source unit, namely light in a wavelength range that is not emitted from the first light source unit. In addition, the second light source unit also emits light in a wavelength range partially overlapping with that of the first light source unit.

The signal generating unit receives light having changing wavelengths emitted from each of the first light source unit and the second light source unit, and generates a signal at every timing when a wave number of the received light becomes equal wave number interval. The signal generating unit specifically includes an optical system having wavelength selection characteristics of equal wave number interval and an element that receives light after passing through the optical system and converts the light into an electric signal to generate the signal. The above-mentioned signal generating unit may be referred to as a wave number clock (k-clock) optical system.

In addition, the first interference light and the second interference light may be detected by using a single light detecting unit, or those may be detected by using different light detecting units.

A temporal waveform of intensity of the first interference light and a temporal waveform of intensity of the second interference light are linked and undergo Fourier transform. Thus, information, typically, a tomographic image of the object can be obtained, which is the same as information obtained in the case of illumination with light in a wavelength range that is a combination of a wavelength range of light emitted from the first light source unit and a wavelength range of light emitted from the second light source unit. However, a tomographic image having a high SN ratio cannot be obtained unless the wave number (frequency) at which the temporal waveform of the intensity of the first interference light and the temporal waveform of the intensity of the second interference light are linked is appropriately selected.

In principle, as the wave numbers at which the temporal waveform of the intensity of the first interference light and the temporal waveform of the intensity of the second interference light are linked are closer to the same, it is expected that an SN ratio of the acquired tomographic image is higher.

Therefore, the temporal waveforms are linked based on timing signals having equal wave number intervals generated from the signal generating unit. For instance, in the temporal waveforms of the first interference light and the second interference light, a candidate wave number at which the temporal waveforms are linked is determined based on data corresponding to the timing at which the signal generating unit generates the signal, and the temporal waveforms are linked at the candidate wave number so as to acquire the tomographic image and to calculate the SN ratio. It is considered that the SN ratio is larger as the wave numbers for the linking are closer to the same. Therefore, it is considered that when the wave numbers at which the temporal waveforms are linked is being changed, the SN ratio is increased to a maximum point and then is decreased. By linking the temporal waveforms at the maximum SN ratio point, a tomographic image having high SN ratio can be acquired.

Further, the wave numbers for the linking are changed by the same wave number for the first interference light and the second interference light from a link wave number (or a link optical frequency) obtained when the linking is performed so that the SN ratio becomes maximum. Thus, the temporal waveform of the intensity of the first interference light and the temporal waveform of the intensity of the second interference light can be linked so that the SN ratio becomes largest. In the link wave number at which the linking is performed so that the SN ratio becomes maximum, it is considered that the temporal waveform of the intensity of the first interference light and the temporal waveform of the intensity of the second interference light have the same wave number. Therefore, as described above, after the state where the same wave number for linking is realized, the wave number for linking is further selected so that the SN ratio of the tomographic image becomes largest. Thus, the tomographic image having the largest SN ratio can be acquired.

There are various methods for performing the linking based on the timing signal having the equal wave number interval generated by the signal generating unit. For instance, there is a method of repeating the following steps. A first candidate of the wave number at which the linking is performed is determined based on data corresponding to generation timing of a signal (second signal) generated after the signal (first signal) having the largest intensity among signals generated from the signal generating unit. Then, a second candidate of the wave number at which the linking is performed is determined based on data corresponding to generation timing of a signal (third signal) generated after the second signal.

In addition, it is possible to calculate an overlapping wavelength range from a wavelength sweep range of the first light source unit and a wavelength sweep range of the second light source unit so as to estimate the link wave number, and to determine the first candidate of the wave number at which the linking is performed from the estimated link wave number so as to perform the linking.

In addition, the second candidate of the wave number at which the linking is performed may be selected to be larger than the first candidate of the wave number at which the linking is performed, or may be selected to be smaller than the first candidate.

The OCT apparatus of this embodiment may be also described as follows. In order to suppress noise generated due to discontinuous link of phases of respective frequency components contained in the interference signals, the OCT apparatus of this embodiment links the interference signals at the same optical frequency so that the phases of the respective frequency components are continuously linked. Thus, higher image quality and improvement of SNR of the OCT image are achieved without using a complicated device.

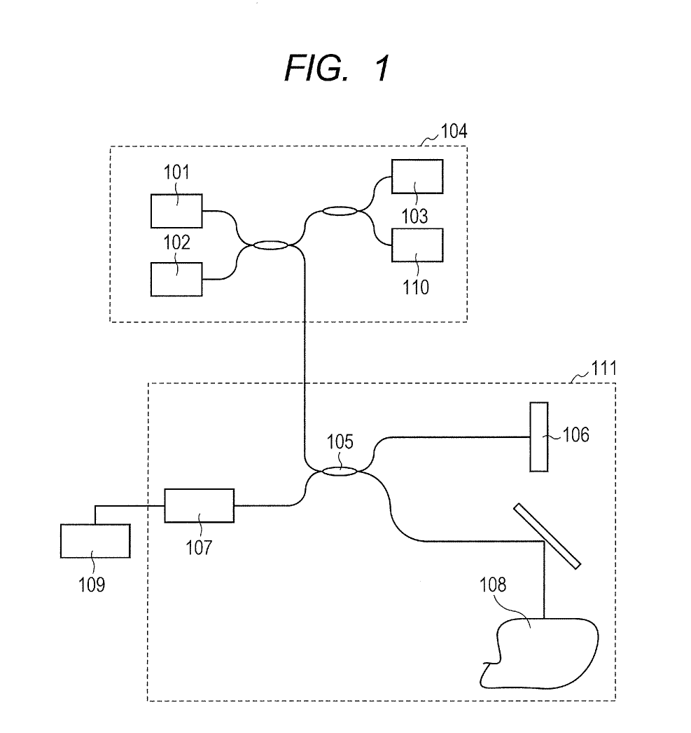

Next, a structural example of the SS-OCT apparatus and the method of acquiring an SS-OCT image in the embodiment of the present invention are described with reference to FIG. 1. Note that, the present invention is not limited by structures of this embodiment and an example described below.

First, a basic structure of the SS-OCT apparatus (hereinafter referred to as an OCT apparatus) of this embodiment is described. The OCT apparatus of this embodiment includes: a light source means including multiple wavelength swept light sources having different wavelength bands with an overlapping part, and a k-clock optical system for measuring wavelength sweep speeds of the wavelength swept light sources; an interference measuring means including an interference optical system for illuminating an object with light from the light source unit so as to obtain an interference signal; and a signal processing means for performing signal processing including image processing based on the interference signal obtained by the interference measuring unit.

Specifically, a light source unit 104 forming the light source means includes a first wavelength swept light source 101 and a second wavelength swept light source 102 as the multiple wavelength swept light sources, a k-clock generating unit (k-clock optical system) 103, and a light source intensity measuring unit 110. There is one k-clock generating unit in FIG. 1, but it is possible to dispose a k-clock generating unit for measuring the wavelength sweep speed of the first wavelength swept light source 101 and another k-clock generating unit for measuring the wavelength sweep speed of the second wavelength swept light source 102.

An interference measuring unit 111 is configured in such a manner that light emitted from the light source unit 104 is split by a coupler 105, and that one light beam illuminates a reference mirror 106 while the other light beam illuminates an object 108. Here, the light beam illuminating the reference mirror 106 is referred to as reference light, and the light beam illuminating the object 108 is referred to as illumination light. Further, the reference light reflected by the reference mirror 106 is guided to the coupler 105, and the illumination light reflected by the object 108 interferes with the reference light at the coupler 105 and is guided to a light detecting unit 107.

Then, a signal processing unit 109 forming the signal processing unit calculates the interference signal detected by the light detecting unit, and hence it is possible to obtain information about a tomographic structure in a depth direction of the object 108 (an optical axis direction of the light illuminating the object 108).

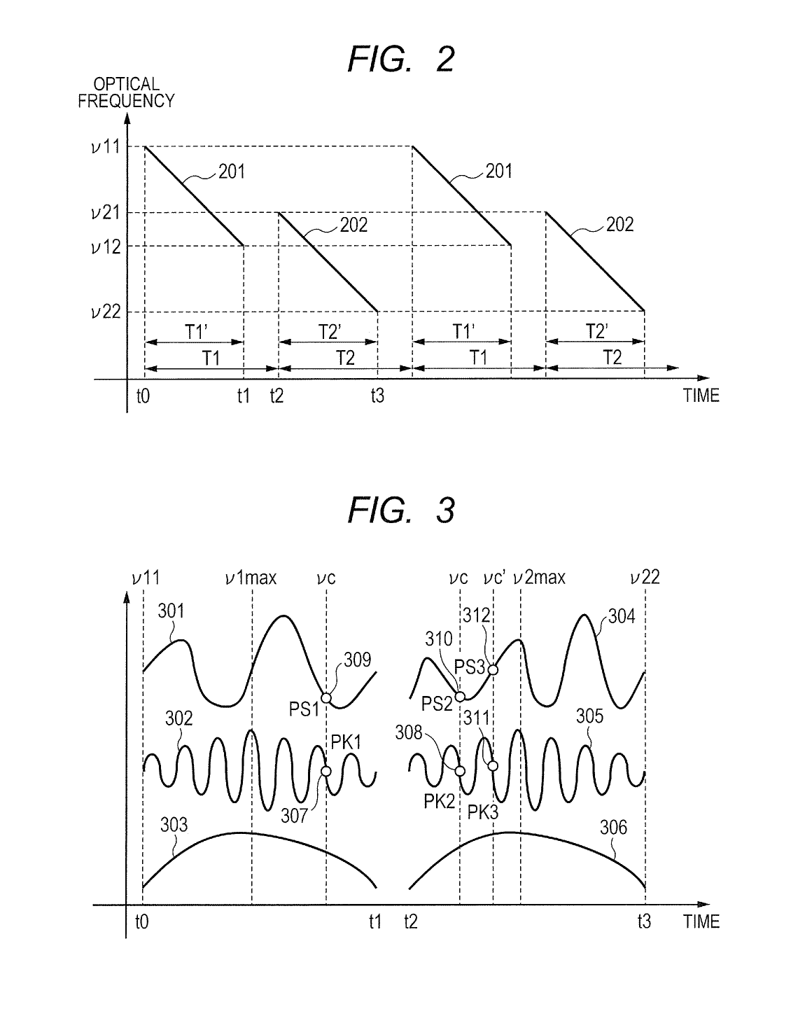

The first wavelength swept light source 101 and the second wavelength swept light source 102 are light sources that sweep optical frequency temporally periodically. FIG. 2 shows an example of temporal changes of optical frequencies of light emitted from the first wavelength swept light source 101 and the second wavelength swept light source 102.

There are shown a graph 201 of sweep of the wavelength swept light source 101 and a graph 202 of sweep of the wavelength swept light source 102. The wavelength swept light source 101 emits light during a time period T1′ from t0 to t1 and sweeps the center frequency from ν11 to ν12. Similarly, the wavelength swept light source 102 sweeps the center frequency from ν21 to ν22 during a time period T2′. A time period from the light emission start time of the first wavelength swept light source 101 to the light emission start time of the second wavelength swept light source 102 is represented by T1. Similarly, a time period from the light emission start time of the second wavelength swept light source 102 to the light emission start time of the first wavelength swept light source 101 is represented by T2. A total period including a non-emission time period is represented by T1+T2. Here, for simplification, it is supposed that T1 is equal to T2, and T1′ is equal to T2′ (FIG. 2). The light beam from the wavelength swept light source 101 is guided to the k-clock generating unit 103 so that a k-clock signal is generated.

The k-clock generating unit includes a Michelson interferometer, for example. A form of the interferometer is not limited to this. A Mach-Zehnder interferometer or other interferometers may be used, or a Fabry-Perot filter or the like may be used. For instance, if an interferometer having an arm length difference L is used, increase or decrease of the light intensity is generated at an interval of the optical frequency of c/2L Hz. The symbol c represents the speed of light. This k-clock signal can be used as a trigger signal having an equal frequency interval necessary for generating the OCT image.

Next, a basic procedure of generating the OCT image in this embodiment is described. FIG. 3 shows temporal waveforms of an interference signal 301, a corresponding k-clock signal 302, and light source intensity 303 when the wavelength swept light source 101 is used for illuminating the object 108 with light. Similarly, FIG. 3 shows temporal waveforms of an interference signal 304, a corresponding k-clock signal 305, and light source intensity 306 when the wavelength swept light source 102 is used for illuminating the object 108 with light.

First, the first wavelength swept light source 101 and the second wavelength swept light source 102 are respectively used to obtain the interference signal 301 (first interference signal) and the interference signal 304 (second interference signal) (first step).

In order to generate a single wide-band interference signal by using the interference signals 301 and 304 acquired by using two light sources having different sweep wavelength bands, it is necessary to link the interference signals 301 and 304 at the same optical frequency point.

Here, it is supposed that the linking is performed at an optical frequency νc. In this case, νc is set to a certain optical frequency between ν12 and ν21 shown in FIG. 2.

An essence of the present invention resides in that the optical frequency νc at which the linking is performed is not necessarily a specific optical frequency but may be within an optical frequency range in which light emission bands of the multiple wavelength swept light sources are overlapped. In other words, although it is important to adjust the optical frequency νc for linking the interference signals obtained from the multiple wavelength swept light sources to be the same optical frequency between the interference signals, it is basically possible to generate the OCT image by performing the linking at any optical frequency νc in the above-mentioned optical frequency range. Description is continued below in view of the above-mentioned point.

In order to link the interference signal 301 and the interference signal 304 at the same optical frequency νc, it is necessary to find a timing at which the optical frequency is νc in the temporal waveforms of the interference signals 301 and 304.

The optical frequency at which the light emission intensity becomes highest can be examined in advance by a spectrum analyzer or the like. If the optical frequency at which the light emission intensity becomes highest is known, an optical frequency difference from there to the optical frequency νc is also known. Therefore, it is possible to roughly find a point considered to be corresponding to the optical frequency νc in each of the interference signals 301 and 304 by using the k-clock signals 302 and 305.

The points considered to be corresponding to the optical frequency νc in the k-clock signals 302 and 305 are determined to be PK1 (307) and PK2 (308) (second step). Further, points in the interference signals 301 and 304 corresponding to these points are referred to as PS1 (309) and PS2 (310).

It is supposed that the optical frequency at which amplitude of the temporal waveform of the k-clock signal 302 obtained by the light source 101 becomes largest is represented by ν1max. This ν1max is the optical frequency at which the light emission intensity becomes highest in the wavelength sweep spectrum of the light source 101.

Next, considering that a peak amplitude of the k-clock signal 302 appears every c/2L Hz, it is roughly estimated which peak or part is PK1 (307) in the k-clock signal 302. In reality, there is a case where a change of amplitude of the k-clock signal is relatively mild in a vicinity of ν1max, and νc is not always found correctly. However, this point is not a problem in the present invention as described later. Similarly, a point corresponding to ν11 is also found in advance. In the similar manner, with respect to the light source 102 too, it is possible to find the optical frequency ν2max having largest amplitude in the k-clock signal 305 and to find a point corresponding to PK2 (308) in the k-clock signal 305 from this ν2max. In addition, a point corresponding to ν22 is also found in advance at the same time.

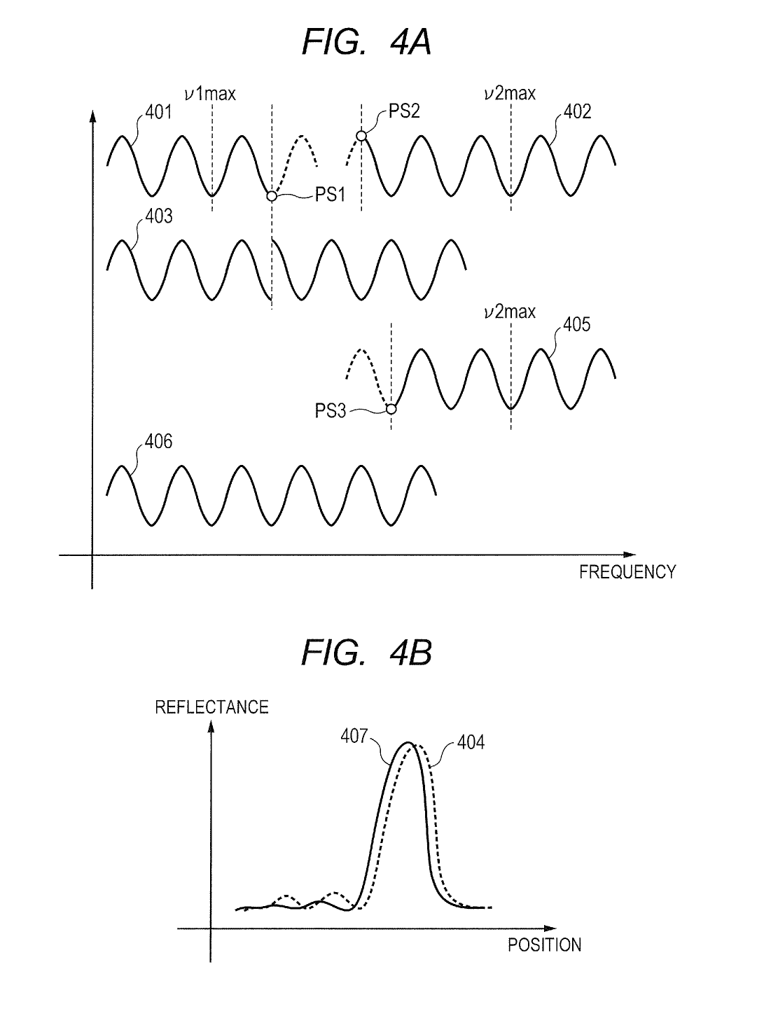

Here, for example, based on a value of the light source intensity 303 measured by the light source intensity measuring unit 110, signal amplitudes of the interference signal 301 obtained by using the light source 101 from ν11 to PS1 (309) are normalized by the light source intensity. Further, sampling is performed again at the equal frequency interval by using the k-clock signal 302 so as to generate an interference signal 401 shown in FIG. 4A. Similarly, based on a signal from PS2 (310) to ν22 in the interference signal 304, sampling is performed again at the equal frequency interval so as to generate an interference signal 402 (FIG. 4A).

The interference signals 401 and 402 are linked so as to generate a combined interference signal 403. Further, Fourier transform of this combined interference signal 403 is performed so as to generate an OCT image (first OCT image) 404 shown in FIG. 4B (third step). In the Fourier transform, an appropriate window function or the like may be multiplied.

In the above-mentioned procedure, if both PS1 and PS2 are truly νc, the interference signals 301 and 304 are linked at the same optical frequency νc.

However, there is considered a case where the optical frequency is different between PS1 and PS2, and hence the interference signals are not linked at the same optical frequency, when the optical frequency at which the k-clock has the largest amplitude is not correctly estimated because an amplitude change of the k-clock signal is mild, for example.

Therefore, as described below, for example, the interference signals are linked based on a frequency obtained by shifting one of the optical frequencies of the interference signals to be linked by one period of the k-clock. In this manner, an OCT image (second OCT image) 407 shown in FIG. 4B is generated (fourth step).

Further, the OCT image 407 is compared with the OCT image 404 generated in the third step so as to evaluate them (fifth step). For instance, PS3 (312) corresponding to PK3 (311) delayed by one period of the k-clock signal from PK2 (308) in the k-clock signal 305 is found in the interference signal 304. Further, an interference signal 405 is generated in the similar manner as the above-mentioned procedure, and the interference signal 401 and the interference signal 405 are linked so that a combined interference signal 406 shown in FIG. 4A is separately generated. Further, Fourier transform of the combined interference signal 406 is performed so as to generate the OCT image 407. Here, SN ratios of the OCT image 404 and the OCT image 407 are compared.

When the interference signals having different wavelength bands are linked to combine a single continuous wide-band interference signal as described above, if the optical frequency is different between PS1 and PS2, a noise occurs in the OCT image because phases of various frequency components contained in the interference signals are discontinuously linked.

On the contrary, by evaluating a noise in the OCT image or an SN ratio of the OCT image and by selecting PS1 and PS2 with respect to the interference signals 401 and 402 so that the SN ratio becomes largest, the interference signals 401 and 402 can be linked at the same optical frequency.

The SN ratio of the OCT image can be evaluated with respect to a region such as, in fundus OCT, for example, a first layer of fundus (surface of retina) at which signal intensity is large and there is no factor to generate an OCT image in front of the region. For instance, if the OCT image 404 and the OCT image 407 are fundus images, the OCT image 404 and the OCT image 407 are compared by evaluating the SN ratio based on a ratio of a peak value of signal intensity of the retina image to a noise value in the front side thereof.

It is determined that the linking of the interference signals having a better SN ratio is closer to the linking at the same optical frequency.

Subsequently, for instance, if the OCT image 407 has a larger SN ratio, PS3 of the interference signal 304 may be further shifted by one period of the k-clock as viewed from νc so as to generate the OCT image by the similar procedure as described above, and the SN ratio thereof may be evaluated. In this way, by repeating the operation of comparing the OCT images obtained by the first interference signal and the second interference signal linked while further shifting the period sequentially until a maximum value of the SN ratio of the OCT image is found, the same optical frequency as the link optical frequency can be found.

Thus the interference signal of the light source 101 and the interference signal of the light source 102 can be linked at the same optical frequency (sixth step).

In addition, the method of evaluating the SN ratio is not limited to the evaluation method using the OCT image. For instance, in the example of the fundus OCT described above, a signal in front of a fundus retina image is considered to contain mainly noise components. Therefore, it is possible adopt an evaluation method in which only the above-mentioned part is extracted from the OCT image and undergoes inverse Fourier transform so that the temporal waveform is restored, and then a link optical frequency at which amplitude of the temporal waveform becomes smallest is searched for.

In addition, similarly in the fundus OCT, if the noise evaluation is performed by using only a low-frequency interference signal corresponding to the interference signal generated apparently from a position in front of the retina image, it is possible to cause the obtained interference signal to pass through an electric low-pass filter, and then to evaluate amplitude thereof.

In addition, other than the evaluation method of searching for the link optical frequency at which the SN ratio becomes largest as described above, it is possible to adopt an evaluation method of searching for a link optical frequency at which signal intensity of the OCT image becomes largest, for example. It is because that the signal intensity becomes maximum at the link optical frequency at which the SN ratio becomes maximum.

Alternatively, it is possible to adopt an evaluation method of extracting only a signal component of such as a retina image from the OCT image to perform the inverse Fourier transform so that the temporal waveform is restored, and then searching for a link optical frequency at which amplitude of the temporal waveform becomes largest.

In addition, similarly in the case of the fundus OCT, if a frequency component of the interference signal from a region having large signal intensity like a retina image is roughly estimated, it is possible to cause the acquired interference signal to pass through an electric band pass filter, and then to evaluate amplitude thereof.

Further, it is also possible to evaluate the SN ratio after forming once an OCT image of a wide area of a target area (such as a fundus) from the OCT signal. In the case of a fundus, for example, it is possible to construct an OCT image first, to find a region estimated to have highest signal intensity on a fundus retina surface from the OCT image in advance, and to use an interference signal from the region so as to evaluate the SN ratio. In order to determine that the SN ratio is largest, it is preferred that the signal intensity be larger in particular. Therefore, a region having high reflectance or the like of the fundus may be found from the OCT image in advance.

In addition, if a maximum value of the SN ratio is not found after repeating the above-mentioned operation within the optical frequency band in which the interference signal is acquired, it is considered that the interference signals 301 and 304 do not contain signals corresponding to the same optical frequency. This is because that the SN ratio of the OCT image is best when the linking is performed at the point corresponding to the same optical frequency, and that the SN ratio of the OCT image obtained from the combined interference signal is always deteriorated if the optical frequencies at which the linking is performed are deviated from each other.

Therefore, if a maximum value of the SN ratio is not found after the optical frequency for the linking is changed as described above regarding the OCT image obtained from the combined interference signal, it is necessary to expand the wavelength sweep band of at least one of the light sources so that the light emission frequency bands of the light source 101 and the light source 102 are overlapped with each other. Therefore, feedback control of the light source is performed to expand the wavelength sweep band. Further, it is necessary to obtain the interference signal again after the sweep band is expanded and to search for the optical frequency for the linking again.

In the OCT apparatus of the present invention, as long as the above-mentioned PS1 and PS2 are the same optical frequency, the value is not necessary to be correctly νc. Therefore, it is not necessary to monitor absolute frequency (or wavelength) of νc accurately by actually using a wavelength filter or a spectroscope. It is possible to generate a wide-band interference signal by linking independent interference signals of multiple light sources, based on the obtained interference signal or k-clock signal.

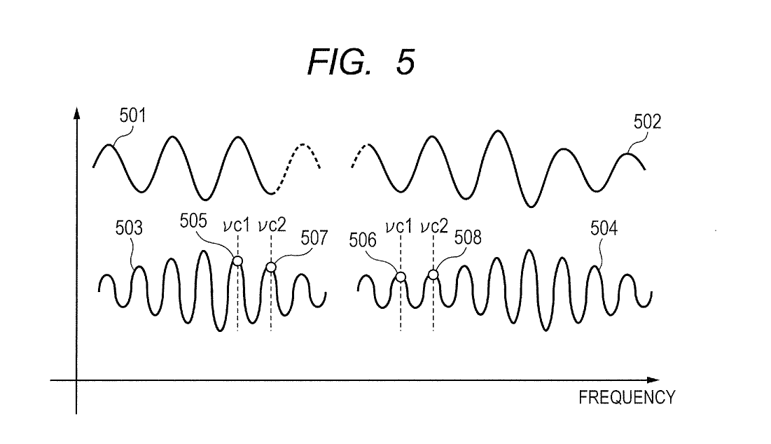

In addition, it is possible to generate the k-clock signal by the interferometer and to perform differential detection by using signals from two output ports of the interferometer. In this case, as shown in FIG. 9, the k-clock signal has a signal waveform vibrating up and down with respect to zero after a DC component is removed. If the k-clock can be acquired as shown in FIG. 9, it is possible to search for a point having the same optical frequency by using a point at which the interference signal intensity becomes zero within the range from νc1 (903) to νc2 (906). This is because that the points at which the k-clock signal intensity becomes zero, except for the optical frequency at which the light emission intensity of the light source becomes zero, are independent of a light emission spectrum shape of the light source itself and always exist at an equal optical frequency interval. However, in general, the light emission spectrum shape of the light source itself is mild and does not contain a steep change. Therefore, in this case, “peaks” and “bottoms” of the k-clock signal as shown in FIG. 5 also exist at a substantially equal optical frequency interval similarly to the above-mentioned points at which the k-clock signal intensity becomes zero. Therefore, it is also possible to generate the k-clock as shown in FIG. 5 so as to constitute the OCT image, by using a k-clock generation system having a simple structure without a differential detector or the like.

In addition, in a case of a stable light source that is not largely change for every sweep because the sweep speed and the light emission band of the light source are stable, it is not necessary to search for the optical frequency for the linking in each wavelength sweep. It is substantially correct that the light emission timing at the optical frequency for the linking in the next wavelength sweep is considered as the time point after one sweep period of the light source from the last light emission timing. Further, it is sufficient to recheck the optical frequency for the linking every few wavelength sweeps in the case of the stable light source. With this operation, it is possible to reduce a calculation load.

In addition, as described below, it is possible to search for the optical frequency at which the interference signals are linked by using a known reference signal.

The beams from the light sources 101 and 102 are split, and parts of them are guided to a reference signal generation system. For instance, the reference signal generation system may be a Fabry-Perot filter including a half mirror pair disposed to face each other via a narrow gap, or may be a Michelson type or other types of interferometer. In addition, a signal having a known single frequency is used as the reference signal. Phases of the reference signal based on the light from the light source 101 and the reference signal based on the light from the light source 102 at the optical frequency for the linking are detected. By monitoring whether or not the phases are continuous at the link point, it is possible to detect in a simplified manner whether or not the optical frequencies for the linking are the same. After determining the optical frequency for the linking, the phases of the reference signals at the link frequency are monitored every sweep. If the phases become discontinuous, the link point is shifted by one period of the k-clock and the phases are monitored again. In this way, by monitoring the known reference signal, it is possible to detect whether or not the link optical frequency is correctly maintained, without calculating the OCT image every time. Therefore, it is possible to reduce the calculation load.

The interference signals can be linked at the same optical frequency by only the operation described above, but it is possible to further perform the following operation.

It is necessary that the interference signals of the light sources 101 and 102 are linked by the same optical frequency, but it is not known that the optical frequency νc determined initially as described above is always optimal. There may be another link optical frequency that can cause a better SN ratio. Therefore, for instance, the points PS1 and PS3 corresponding to the same optical frequency are found in the interference signal 401 and the interference signal 405 shown in FIG. 4A, and then the points PS1 and PS3 may be increased or decreased simultaneously by one period of the k-clock so as to generate the combined interference signal. Then, the SN ratio of the OCT image may be evaluated in the similar manner. This operation can further improve the SN ratio of the OCT image. In addition, in this operation, it is not necessary to increase or decrease the frequency by integral multiplication of the k-clock.

A specific structural example is described below with reference to FIG. 5.

It is supposed that k-clock signals 503 and 504 are obtained with respect to interference signals 501 and 502. It is supposed that the optical frequency is already associated with the k-clock signal in the above-mentioned procedure. It is supposed that a point 505 in the k-clock signal 503 and a point 506 in the k-clock signal 504 have the same optical frequency νc1. In addition, a point 507 and a point 508 have the same optical frequency νc2 that is different from the above-mentioned optical frequency.

It is necessary to link the interference signals 501 and 502 at the same optical frequency. On the other hand, there is no limitation in the value of the optical frequency for the linking. In other words, the optical frequency may be any value as long as the multiple light sources emit light so that the interference signals are obtained. In other words, if the corresponding optical frequencies of the multiple light sources are found in the k-clock signals as described above, the interference signals 501 and 502 can be arbitrarily linked at any optical frequency in the optical frequencies.

Therefore, it is detected at which optical frequency the linking may be performed so that a good SN ratio of the OCT image can be obtained, that is, whether the linking is performed at the point 505 and the point 506, or at the point 507 and the point 508. Thus, the condition that “the interference signals are linked at the same optical frequency” is satisfied, while the optical frequency that causes the best SN ratio of the interference signal can be searched for. By repeating this operation, it is possible to achieve higher image quality of the OCT image produced from the combined interference signal. In this way, with the structure of this embodiment, it is possible to improve OCT image quality and to acquire an image with high SN ratio without using an additional complicated device such as a high-accuracy wavelength monitor.

In addition, the structure described above includes the wavelength swept light source and the signal generating unit for generating signals having the equal frequency interval based on the light from the wavelength swept light source, but the present invention is not limited to this structure. For instance, it is possible to use a wavelength swept light source such as a super structure grating DBR laser (SSG-DBR laser), in which the light emission wavelengths inherently have the equal frequency interval. In a general wavelength swept light source, the oscillation wavelength changes continuously with time. In contrast, when temporal wavelength sweep is performed in the SSG-DBR laser, the light emission wavelength changes discretely with time. Further, the discrete light emission wavelengths have the equal frequency interval.

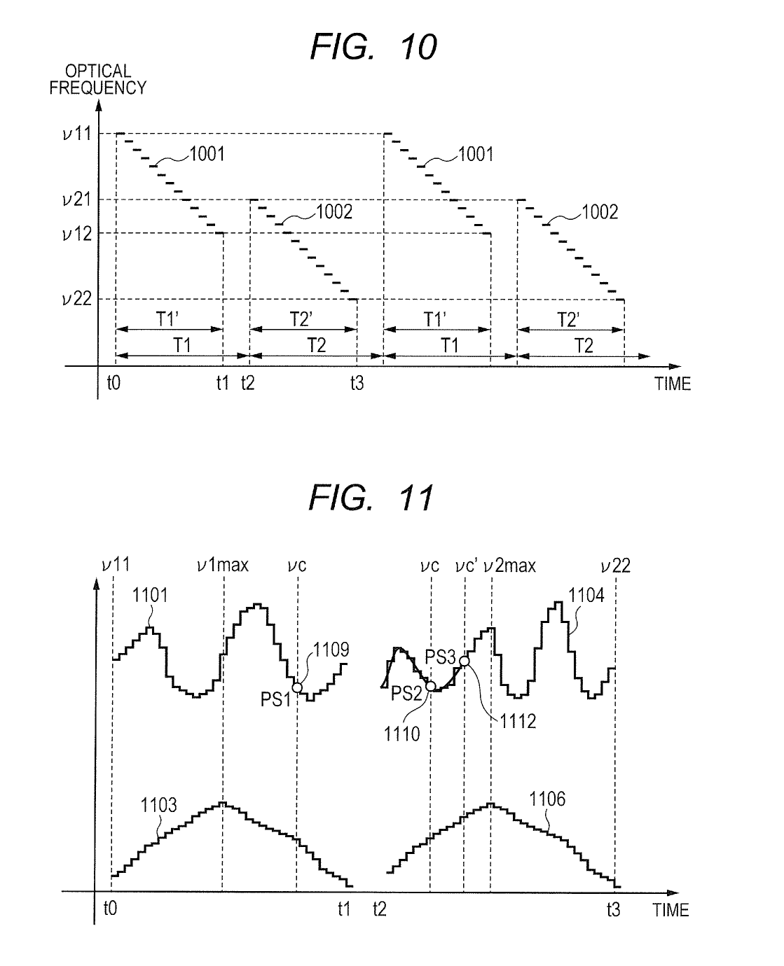

In the case where the light source 101 and the light source 102 are SSG-DBR lasers, the temporal changes of the optical frequencies of the light emitted from the SSG-DBR lasers are shown in FIG. 10, and an example of the obtained interference signals is are shown in FIG. 11. In FIG. 10, an optical frequency 1001 of the light source 101 and an optical frequency 1002 of the light source 102 are shown. If the interval of the optical frequencies of light that can be emitted from the SSG-DBR laser is close to the interval of the optical frequencies of the above-mentioned k-clock signal, it is possible to obtain the interference signals having the equal frequency interval without using the signal generating unit.

FIG. 11 shows an interference signal 1101 and light source intensity 1103 of the light source 101 in a case where the SSG-DBR laser is used for the light source 101. Similarly, an interference signal 1104 and light source intensity 1106 of the light source 102 in a case where the SSG-DBR laser is used for the light source 102 are shown. Because the optical frequency of the light source changes discretely, a waveform of the interference signal becomes a stair-like shape.

Further, as to the optical frequency νc at which the interference signals 1101 and 1104 from two light sources are linked, in the similar manner as described above, for example, the optical frequency at which the light source intensity becomes largest is examined by an optical spectrum analyzer or the like in advance. Thus, an optical frequency νc 1109 at which the linking is to be performed can be roughly estimated. In the interference signal 1104 too, a corresponding optical frequency νc 1112 can be estimated in the similar manner. Alternatively, it is possible to roughly estimate the light emission wavelength of the light source at a certain time point based on a current signal supplied to a DBR section of the SSG-DBR laser in order that frequency of the light source is changed.

Further, also when the optical frequency for the linking is shifted sequentially at the equal frequency interval so as to form the OCT image sequentially, the interference signal 1101 or the light source intensity 1103 is referred to so that the optical frequency νc for the linking can be shifted at the equal frequency interval.

In addition, if the optical frequency interval of the SSG-DBR laser is sufficiently smaller than the optical frequency interval of the k-clock used in the above description, it is possible to cause the light from the SSG-DBR laser to pass through the signal generating unit so as to generate the k-clock signal having a desired optical frequency interval in the similar manner as the case where the light source is a normal wavelength swept light source.

### Example

An example of the present invention is described below. In this example, a structural example of the SS-OCT apparatus and a method of acquiring an SS-OCT image to which the present invention is applied are described.

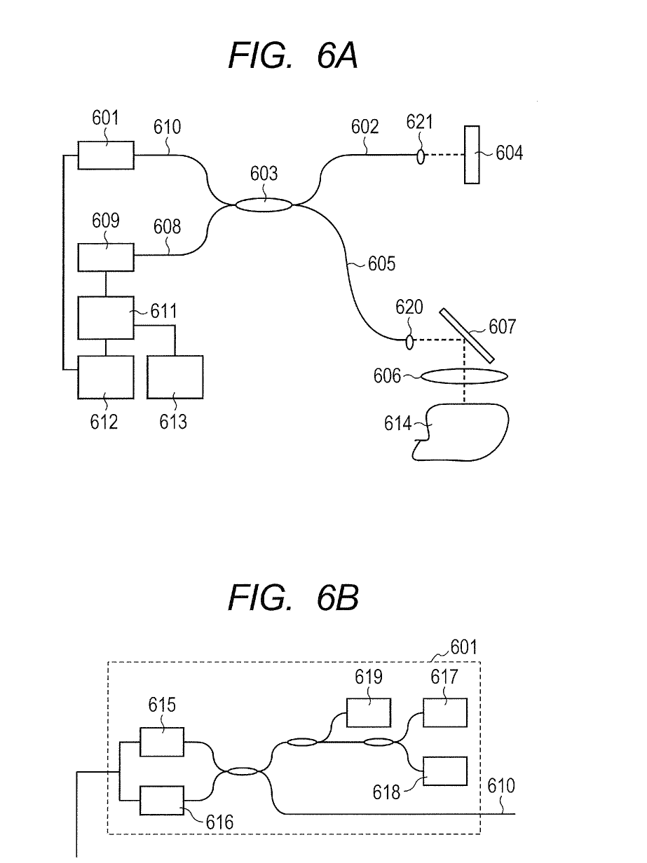

FIG. 6A illustrates a structural diagram thereof. Here, it is supposed that an examination object 614 corresponding to the object 108 is a fundus. There are disposed a wavelength swept light source unit 601 forming the light source unit, a reference light optical path fiber 602 and a collimator lens 621 and a reflection mirror 604 forming a reference unit, and a fiber coupler 603 forming an interference unit. Further, an illumination light optical path fiber 605, a collimator lens 620, an illumination light condensing optical system 606, and an illumination position scanning mirror 607 forming a sample measurement unit are connected. In addition, a light receiving fiber 608 and a photodetector 609 forming the light detecting unit, an illumination fiber 610, a signal processing device 611 forming an image processing unit, and an image output monitor 613 are connected. Further, a light source control device (light source control unit) 612 forming the light source unit is connected. Thus, an optical tomographic imaging apparatus can be formed. Further, the fiber forming the interference optical system includes a single mode fiber in this example, and various fiber couplers each include a 3 dB coupler, but the present invention is not limited to this structure. In addition, as illustrated in FIG. 6B, the wavelength swept light source unit 601 includes a wavelength swept light source 615, a wavelength swept light source 616, a k-clock system 617, a light source intensity detector 618, and a reference interferometer 619.

In this example, as the k-clock system, a Michelson interferometer is used, in which a difference between arm lengths of the interferometer is 8 mm. The interference signal output from this interferometer generates the k-clock signal at every 18.737 GHz of the optical frequency.

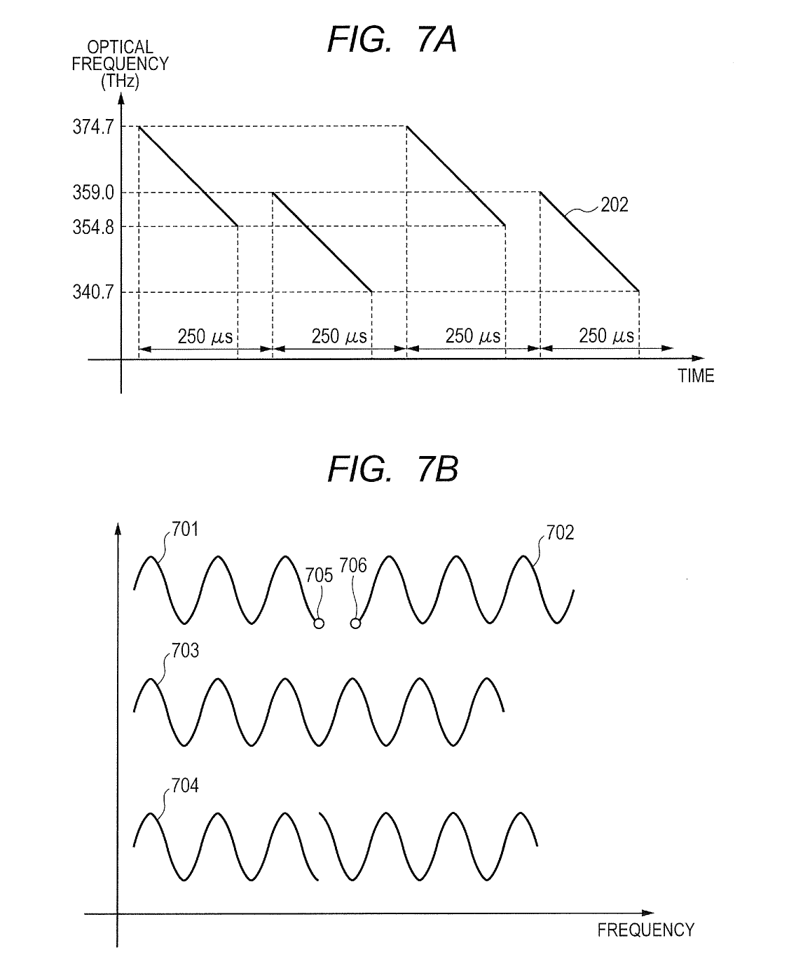

The wavelength swept light sources 615 and 616 are supplied with a control signal from the light source control device 612. The oscillation wavelength and the intensity of the wavelength swept light source, and the temporal change thereof are controlled by the light source control device. In this example, the wavelength swept light source 615 has a light emission wavelength of 800 nm (374.7 THz) to 845 nm (354.8 THz), and a largest light emission intensity wavelength of 830 nm (361.2 THz). The wavelength swept light source 616 has a light emission wavelength of 835 nm (359.0 THz) to 880 nm (340.7 THz), and a largest light emission intensity wavelength of 860 nm (348.6 THz). Both the light sources have a wavelength sweep period of 500 μs (see FIG. 7A).

Light beams emitted from the wavelength swept light sources 615 and 616 are each split and guided by the fiber coupler into the reference light optical path fiber 602 and the illumination light optical path fiber 605. Further, a reflection mirror is disposed on a distal end of the reference light optical path fiber. The light is reflected by the reflection mirror to be guided to the light receiving fiber and reaches the photodetector. At the same time, the light guided by the fiber coupler into the illumination light optical path fiber illuminates a sample object, and back scattering light is generated from the inside and the surface of the sample object. The back scattering light is condensed through the illumination light condensing optical system and guided to the photodetector by the fiber coupler. The light received by the photodetector is converted into a spectrum signal by the signal processing device and further undergoes Fourier transform so that depth information of the sample object is obtained.

In this example, the OCT image is formed as follows.

First, the interference signal obtained by using the wavelength swept light source 615 and the interference signal obtained by using the wavelength swept light source 616 are linked at a wavelength of 840 nm (356.9 THz). A frequency difference from between 830 nm (359.0 THz) as the largest light emission intensity wavelength of the wavelength swept light source 615 and the link optical frequency is approximately 2.1 THz, which corresponds to 112 peaks of the k-clock signal. Therefore, in the k-clock signal generated with respect to the wavelength swept light source 615, the 112th peak from the point at which the k-clock signal becomes the largest amplitude toward the low frequency side of the optical frequency is regarded as the link frequency. Similarly, the largest light emission intensity wavelength of the wavelength swept light source 616 is 860 nm (348.6 THz), and a frequency difference to the link optical frequency is 8.3 THz. Therefore, this corresponds to approximately 443 peaks of the k-clock signal. Therefore, in the k-clock signal generated with respect to the wavelength swept light source 616, the 443rd peak from the point at which the k-clock signal becomes the largest amplitude toward the high frequency side of the optical frequency is regarded as the link frequency.

Then, the amplitudes of the interference signal obtained by using the wavelength swept light source 615 and the interference signal obtained by using the wavelength swept light source 616 are normalized by using the light source intensity spectrums measured by the light source intensity detector 618 in advance.

Further, resampling of each of the interference signals is performed by using the k-clock signal at the equal frequency interval. When the resampling is performed, linear interpolation or spline interpolation of data of each of the interference signals may be used if necessary.

Further, the interference signals after the resampling at the equal frequency interval are linked at a wavelength of 840 nm (356.9 THz). Thus, the OCT image is produced by using the linked interference signal.

At the same time, another OCT image is also produced in the case where the 444th peak from the point at which the k-clock signal becomes the largest amplitude toward the high frequency side of the optical frequency is regarded as the link frequency as the link position of the interference signal obtained by using the wavelength swept light source 616, and the produced OCT images are compared. For instance, if the OCT image in the case where the linking is performed at the 444th peak of the k-clock signal has a larger SN ratio, the comparison of the SN ratio is performed with an OCT image in which the linking is performed at the 445th peak of the k-clock signal, which is obtained by further shifting by one peak toward the high frequency side. This operation is repeated so as to find a condition in which the SN ratio of the OCT image becomes best.

The evaluation of the SN ratio of the OCT image can be performed by evaluating noise generated in a space in front of the forefront surface of the retina at which the signal intensity is highest and there is no signal generation source in front thereof. In this case, a ratio of intensity of the retina image to noise intensity is regarded as the SN ratio.

If a maximum value of the SN ratio is not found even in the case that the image is produced while the link optical frequency is shifted as described above, the wavelength sweep bands of the wavelength swept light sources 615 and 616 may be smaller than the assumed value in reality, and as a result there may not be the overlapping band. Therefore, in this case, it is necessary to send out a control signal from the light source control device 612 to the wavelength swept light sources so as to expand the wavelength sweep ranges thereof, and to acquire the interference signals again using the light sources.

In this way, by finding a maximum value of the SN ratio of the OCT signal, a high resolution OCT image by the wide band light source using multiple light sources can be produced without using a high-accuracy wavelength monitor or the like.

In addition, if a link condition in which the SN ratio of the OCT signal becomes maximum is found, the following operation may be continued.

It is supposed that the corresponding optical frequencies at the link position of the interference signals are the same when the signals are linked at the 112th peak of the k-clock signal of the wavelength swept light source 615 and the 445th peak of the k-clock signal of the wavelength swept light source 616. It is supposed that this is found by the maximum value of the SN ratio described above. Here, it is possible to shift the link optical frequency by one peak toward the high frequency side from the 112th peak of the k-clock signal of the wavelength swept light source 615 to the 111th peak, and simultaneously to shift the link optical frequency by one peak toward the high frequency side from the 445th peak of the k-clock signal of the wavelength swept light source 616 to the 446th peak. It is because even if the link optical frequencies are each shifted by one peak of the k-clock, the relationship of the same optical frequency is maintained as long as the same k-clock system is used. In this way, it is possible to further change the optical frequency for the linking by one peak (by one period) of the k-clock signal or by a constant frequency other than one period while maintaining the state of the same optical frequency for the linking, so as to search for the link optical frequency at which the SN ratio of the OCT image becomes best.

Further, after the optical frequency for the linking is once found through the above-mentioned procedure, it is possible to use the reference interferometer 619 for monitoring the gap of the link wavelength in a simplified manner. As the reference interferometer, a Fabry-Perot etalon having a thickness of 1 mm is used in this example. The interference signal obtained by the etalon having a thickness of 1 mm has a frequency of 149.9 GHz. Note that, the frequency of the interference signal generated by the reference interferometer is not limited to this value.

If the optical frequency for the linking is the same, as shown in FIG. 7B, interference signals 701 and 702 obtained when the light beams from the wavelength swept light sources 615 and 616 enter the reference interferometer are linked at a continuous phase. Thus, a smoothly linked signal like a combined interference signal 703 is obtained. However, if the optical frequency for the linking varies due to a fluctuation of the light source or the like, the linking is performed at a discontinuous phase as in a combined interference signal 704. Therefore, phases of the reference signal at link points 705 and 706 may be monitored so as to check whether or not the phase is continuous. Thus, it is possible to detect whether or not the link optical frequency is the same between the interference signals 701 and 702 in a simplified manner. Therefore, this link optical frequency control may be performed. If a phase gap is detected, control is made to change the optical link frequency of the interference signals so that a correct optical link frequency is searched for.

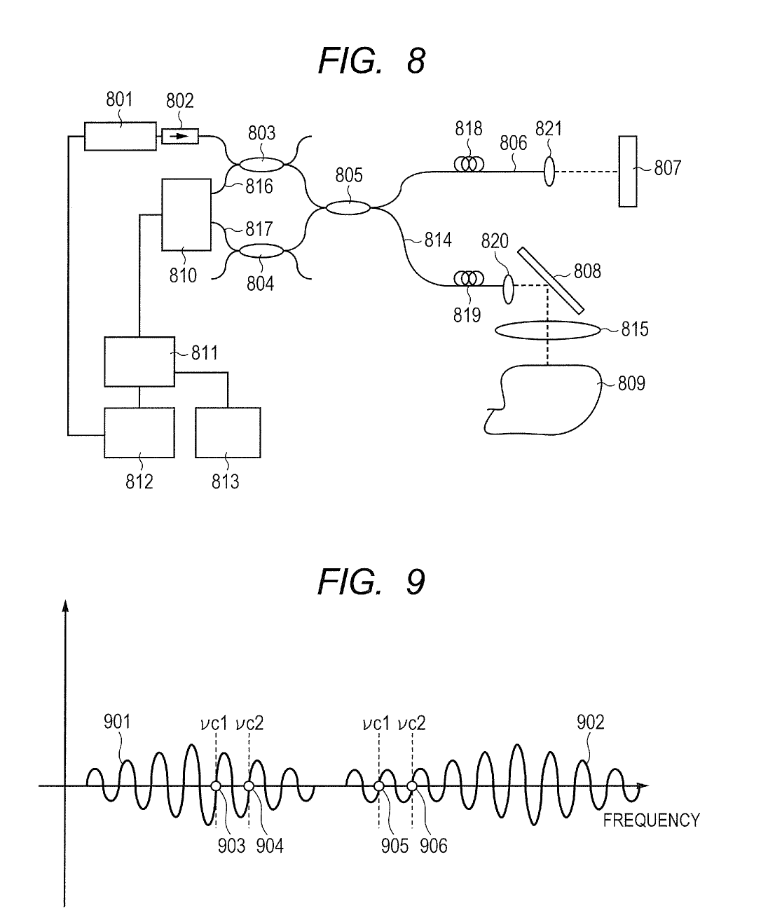

In addition, the structure illustrated in FIG. 6A is used as an interference measuring system in the above description, but the present invention is not limited to this structure. For instance, as illustrated in FIG. 8, it is possible to adopt a structure of using a differential detector for acquiring the interference signal. In FIG. 8, a light source unit 801, an isolator 802, a reference light optical path fiber 806 and a polarization controller 818 and a collimator lens 821 and a reflection mirror 807 forming the reference unit, and a fiber coupler 805 forming the interference unit are disposed. Further, an illumination light optical path fiber 814, a polarization controller 819, a collimator lens 820, an illumination light condensing optical system 815, and an illumination position scanning mirror 808 forming the sample measurement unit are connected, and an examination object 809 is disposed. In addition to this, a fiber coupler 803, a fiber coupler 804, a light receiving fiber 816, a light receiving fiber 817, and a balance photodetector 810 forming the light detecting unit, a signal processing device 811 forming the image processing unit, and an image output monitor 813 are connected. Further, a light source control device 812 forming the light source unit is connected. Thus, the optical tomographic imaging apparatus can be formed.

### REFERENCE SIGNS LIST

301: interference signal
302: k-clock signal
303: light source intensity
304: interference signal
305: k-clock signal
306: light source intensity
401: interference signal
402: interference signal
403: combined interference signal
404: OCT image
405: interference signal
406: combined interference signal
407: OCT image

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-251920, filed Nov. 16, 2012, which is hereby incorporated by reference herein in its entirety.

1. An OCT apparatus, comprising:
a first light source unit arranged to change an optical wavelength;
a second light source unit arranged to change an optical wavelength over a wavelength range different from and partially overlapping with a wavelength range of the first light source unit;
a signal generating unit arranged to receive light emitted from the first light source unit and light emitted from the second light source unit so as to generate a signal at an equal wave number interval;
an interference optical system arranged to split each of the light emitted from the first light source unit and the light emitted from the second light source unit into illumination light that illuminates an object and reference light, so as to generate interference light of reflection light of the light illuminating the object and the reference light;
a light detecting unit arranged to receive first interference light obtained based on the light emitted from the first light source unit and second interference light obtained based on the light emitted from the second light source unit; and
an information acquiring unit configured to acquire a tomographic image of the object by linking a temporal waveform of intensity of the first interference light and a temporal waveform of intensity of the second interference light,
wherein the information acquiring unit links the temporal waveform of the intensity of the first interference light and the temporal waveform of the intensity of the second interference light based on the signal generated from the signal generating unit.

2. An OCT apparatus according to claim 1, wherein the information acquiring unit performs the linking so that an SN ratio of the tomographic image obtained by linking the temporal waveform of the intensity of the first interference light and the temporal waveform of the intensity of the second interference light becomes maximum.

3. An OCT apparatus according to claim 2, wherein the information acquiring unit changes a wave number for the linking at an equal wave number interval from a link wave number obtained when the linking is performed so that the SN ratio becomes maximum, and links the temporal waveform of the intensity of the first interference light and the temporal waveform of the intensity of the second interference light so that the SN ratio becomes largest.

4. An SS-OCT apparatus, comprising:
a light source unit arranged to include multiple wavelength swept light sources, and a k-clock optical system arranged to measure wavelength sweep speeds of the multiple wavelength swept light sources;
an interference measuring unit arranged to include an interference optical system arranged to illuminate an object with light emitted from the light source unit so as to obtain an interference signal; and
a signal processing unit configured to perform signal processing including image processing with the interference signal obtained by the interference measuring unit, wherein:
the light source unit includes, as the multiple wavelength swept light sources, the wavelength swept light sources including at least a first wavelength swept light source and a second wavelength swept light source having different and partially overlapping wavelength ranges; and
the signal processing unit is configured to:
link a first interference signal of the first wavelength swept light source and a second interference signal of the second wavelength swept light source, which are obtained by the interference measuring unit, at a link optical frequency found by using a signal obtained by the k-clock optical system, in order to suppress noise generated when phases of respective frequency components contained in the first interference signal and the second interference signal are discontinuously linked; and
produce an OCT image based on the first interference signal and the second interference signal linked at the link optical frequency.

5. An SS-OCT apparatus according to claim 4, wherein the signal processing unit is configured to:
compare an SN ratio of the OCT image between a first OCT image corresponding to the OCT image produced based on the first interference signal and the second interference signal linked at the link optical frequency determined by using the signal obtained by the k-clock optical system and a second OCT image produced based on the first interference signal and the second interference signal linked at a frequency shifted by a period from the link optical frequency determined by using the signal obtained by the k-clock optical system;
repeat comparison with the OCT image obtained based on the first interference signal and the second interference signal linked while further shifting the period sequentially, until a maximum value of the SN ratio is obtained; and
find the link optical frequency for the first interference signal and the second interference signal by the repetition.

6. An SS-OCT apparatus according to claim 4, wherein when a maximum value of the SN ratio is not obtained by the comparison of the SN ratio, at least one of wavelength sweep ranges of the first wavelength swept light source and the second wavelength swept light source is expanded by a light source control unit configured to control the multiple wavelength swept light sources forming the light source unit, and the first interference signal and the second interference signal are acquired again based on light emitted from the light source unit.

7. A method of acquiring an SS-OCT image by illuminating an object with light emitted from a light source unit including multiple wavelength swept light sources and a k-clock optical system arranged to measure wavelength sweep speeds of the multiple wavelength swept light sources, and performing image processing of an obtained interference signal using a signal processing unit configured to perform signal processing including the image processing, the method comprising:
a first step of acquiring a first interference signal of the first wavelength swept light source and a second interference signal of the second wavelength swept light source using at least two wavelength swept light sources including a first wavelength swept light source and a second wavelength swept light source having different and partially overlapping wavelength ranges as the multiple wavelength swept light sources;
a second step of determining a link optical frequency using a signal obtained by the k-clock optical system in order to suppressing noise generated due to discontinuous link of phases of respective frequency components contained in the first interference signal and the second interference signal, when the first interference signal and the second interference signal are linked; and
a third step of linking the first interference signal and the second interference signal at the link optical frequency determined by using the k-clock optical system, so as to produce an OCT image based on the linked first interference signal and second interference signal.

8. A method of acquiring an SS-OCT image according to claim 7, further comprising, after the third step:
a fourth step of shifting a period of the link optical frequency determined by using the k-clock optical system, so as to produce a second OCT image based on the first interference signal and the second interference signal linked while shifting the period;
a fifth step of comparing an SN ratio of the OCT image between a first OCT image corresponding to the OCT image produced based on the first interference signal and the second interference signal linked at the link optical frequency determined by using the k-clock optical system in the third step and the second OCT image produced in the fourth step; and
a sixth step of repeating comparison with the OCT image obtained based on the first interference signal and the second interference signal linked while further shifting the period sequentially, until a maximum value of the SN ratio is obtained, so as to find the link optical frequency for linking the first interference signal and the second interference signal by the repetition.

9. A method of acquiring an SS-OCT image according to claim 8, wherein:
the second step includes a step of regarding a frequency at which amplitude of the signal obtained by the k-clock optical system becomes largest as a frequency at which light emission intensity is largest, so as to determine the link optical frequency for the first interference signal and the second interference signal based on the frequency;
the fourth step includes shifting the link optical frequency determined by using the k-clock optical system in the second step by one period, so as to produce the second OCT image based on the first interference signal and the second interference signal linked after the shift by the one period; and
the sixth step includes:
comparing the SN ratio between the first OCT image and the second OCT image;
shifting the link optical frequency determined by using the k-clock optical system by one period in a direction that increases the SN ratio of each of the first OCT image and the second OCT image;
repeating, when comparing with the OCT image produced based on the first interference signal and the second interference signal linked after the shift by the one period, comparison with the OCT image obtained based on the first interference signal and the second interference signal linked after further sequential shift of the period, until the maximum value SN ratio is obtained; and
finding the link optical frequency for the first interference signal and the second interference signal by the repetition.

10. A method of acquiring an SS-OCT image according to claim 9, further comprising, after the sixth step and after the repetition until the SN ratio of the OCT image becomes the maximum value, further changing the link optical frequency by a constant frequency so as to repeat comparison with the OCT image produced based on the first interference signal and the second interference signal linked at the changed optical frequency until the largest value of the SN ratio is obtained, and finding the link optical frequency for the first interference signal and the second interference signal by the repetition.

11. A method of acquiring an SS-OCT image according to claim 7, further comprising:
expanding, when the maximum value of the SN ratio is not obtained by the comparison of the SN ratio, at least one of wavelength sweep ranges of the first wavelength swept light source and the second wavelength swept light source by a light source control unit configured to control the multiple wavelength swept light sources forming the light source unit; and
acquiring the first interference signal and the second interference signal again based on light emitted from the light source unit.

12. An OCT apparatus, comprising:
a first light source unit arranged to change an optical wavelength at an equal frequency interval;
a second light source unit arranged to change an optical wavelength at an equal frequency interval over a wavelength range different from and partially overlapping with a wavelength range of the first light source unit;
an interference optical system arranged to split each of light emitted from the first light source unit and light emitted from the second light source unit into illumination light that illuminates an object and reference light, so as to generate interference light of reflection light of the light illuminating the object and the reference light;
a light detecting unit arranged to receive first interference light obtained based on the light emitted from the first light source unit and second interference light obtained based on the light emitted from the second light source unit; and
an information acquiring unit configured to acquire a tomographic image of the object by linking a temporal waveform of intensity of the first interference light and a temporal waveform of intensity of the second interference light,
wherein the information acquiring unit links the temporal waveform of the intensity of the first interference light and the temporal waveform of the intensity of the second interference light based on one of a signal generated from each of the first light source unit and the second light source unit, and the first interference light and the second interference light.
